(19) United States
(12) Patent Application Publication
(10) Pub. No.: US 2024/0406497 A1
(43) Pub. Date: Dec. 5, 2024

(54) TECHNIQUES FOR AUTOMATICALLY GENERATING REPLAY CLIPS OF MEDIA CONTENT FOR KEY EVENTS

(71) Applicant: Apple Inc., Cupertino, CA (US)

(72) Inventors: Carlos ROIG MARI, Barcelona (ES); Philip ZEPEDA, Los Angeles, CA (US); David VARAS GONZALEZ, Barcelona (ES); Adrià CAELLES PRAT, Barcelona (ES)

(21) Appl. No.: 18/458,111

(22) Filed: Aug. 29, 2023

Related U.S. Application Data
(60) Provisional application No. 63/506,073, filed on Jun. 3, 2023.

(51) Int. Cl. H04N 21/44; H04N 21/845

(52) U.S. Cl. CPC H04N 21/44008; H04N 21/8456

(57) ABSTRACT

Disclosed herein are techniques for dynamically generating replay clips for key events that occur. According to some embodiments, one technique can be implemented at a computing device, and includes the steps of (1) providing media content to at least one machine learning model to output a plurality of segments of the media content, where each segment is tagged with a respective at least one classification that describes a nature of the segment, (2) receiving a plurality of key events, and (3) for each key event of the plurality of key events: analyzing at least one segment of the plurality of segments against the key event to determine starting and ending points for a replay clip for the key event, and generating the replay clip based on (i) the media content, and (ii) the starting and ending points.

### CROSS-REFERENCE TO RELATED APPLICATIONS

The present application claims the benefit of U.S. Provisional Application No. 63/506,073, entitled “TECHNIQUES FOR AUTOMATICALLY GENERATING REPLAY CLIPS OF MEDIA CONTENT FOR KEY EVENTS,” filed Jun. 3, 2023, the content of which is incorporated by reference herein in its entirety for all purposes.

### FIELD

The described embodiments set forth techniques for automatically generating replay clips of media content for key events. In turn, the key events and their respective replay clips can be presented to users for viewing.

### BACKGROUND

The number of real-world events that may be of interest to individuals continues to only grow as time goes on. This is a result of, for example, the ever-increasing number of events that are taking place in the world and the decrease in production and distribution costs to capture and disseminate the coverage of the events to viewers worldwide. In this regard, it can be overwhelming for individuals to watch all of the events that may be of interest to them. It can further be difficult to curate replay clips in which individuals may be interested in reviewing.

### SUMMARY

This Application sets forth techniques for automatically generating replay clips of media content for key events. In turn, the key events and their respective replay clips can be presented to users for viewing.

One embodiment sets forth a method for dynamically generating replay clips for key events that occur. According to some embodiments, the method can be implemented at a computing device, and includes the steps of (1) providing media content to at least one machine learning model to output a plurality of segments of the media content, where each segment is tagged with at least one respective classification that describes a nature of the segment, (2) receiving a plurality of key events, and (3) for each key event of the plurality of key events: analyzing at least one segment of the plurality of segments against the key event to determine starting and ending points for a replay clip for the key event, and generating the replay clip based on (i) the media content, and (ii) the starting and ending points.

The method may further comprise selecting the at least one machine learning model based on one or more of a type of the media content, a type of an event to which the media content corresponds, or a type of a device that generates the media content.

The method may further comprise, for each key event, analyzing optical flow of the plurality of segments against the key event to determine the starting and ending points for the replay clip for the key event. The optical flow may comprise one or more of a camera panning direction, a change in camera panning direction, a change in camera panning speed, a change in camera zoom level, a change in camera zoom speed, or a change in camera source video.

The method may further comprise, for each key event, analyzing audio data of the plurality of segments against the key event to determine the starting and ending points for the replay clip for the key event.

The media content may comprise media content from a plurality of different video sources. The replay clip may be generated using the media content from the plurality of different video sources. For example, the replay clip may be generated using the media content by splicing different ones of the plurality of different video sources to create an optimal replay clip. One or more of the plurality of segments of the media content between the starting and ending points may be omitted from the replay clip based on their respective classification(s).

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of a system for implementing the various techniques described herein, according to some embodiments.

FIG. 2 illustrates a sequence diagram of interactions between an event activity provider, a media content analyzer, a media content library, and a client computing device (of FIG. 1) to enable the techniques discussed herein to be implemented, according to some embodiments.

FIG. 3 illustrates a method for dynamically generating replay clips based on key events that occur, according to some embodiments.

FIGS. 4A-4F illustrate conceptual diagrams of an example process through which a client computing device classifies media content, according to some embodiments.

FIG. 5 illustrates a detailed view of a representative computing device that can be used to implement various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

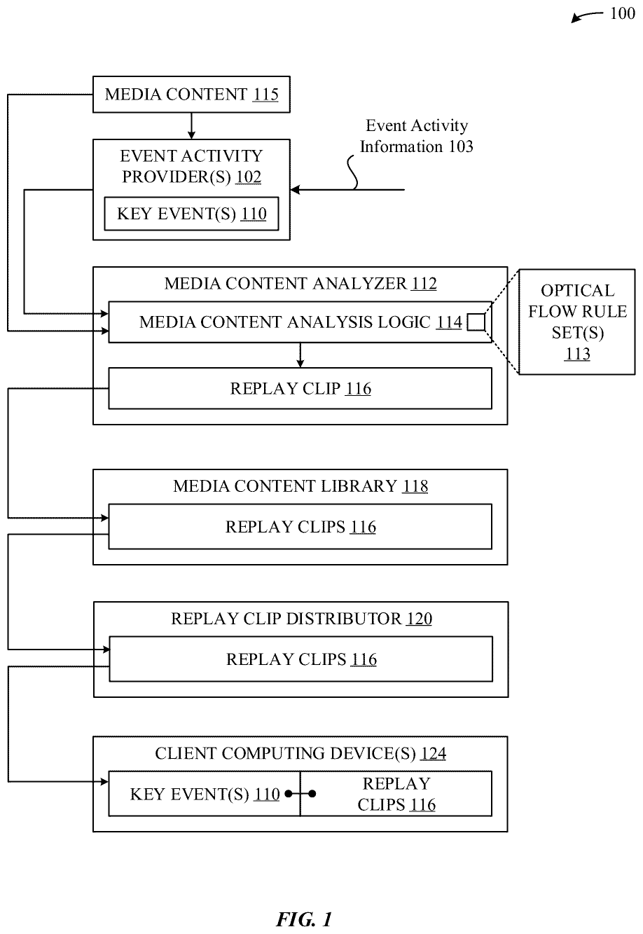

FIG. 1 illustrates a block diagram of different components of a system 100 for implementing the various techniques described herein, according to some embodiments. As shown in FIG. 1, the system 100 includes one or more event activity providers 102, one or more media content analyzers 112, one or more media content libraries 118, one or more replay clip distributors 120, and one or more client computing devices 124.

According to some embodiments, a given event activity provider 102 can be configured to obtain information pertaining to real-world events that take place, which is illustrated in FIG. 1 as event activity information 103. In turn, the event activity provider 102 can be configured to generate key events 110 based on the event activity information 103. In one example, the event activity provider 102 can implement an application programming interface (API) that enables information associated with the real-world events to be provided to the event activity provider 102. The real-world information can be obtained/provided using any conceivable approach without departing from the scope of this disclosure. For example, one or more computing devices can be located at a sports stadium and be configured to gather information under automated, semi-automated, or manual approaches. As an example of the automated approach, one or more sensors, cameras, etc., can be utilized to automatically parse and report events as they take place (e.g., using machine learning). As an example of the semi-automated approach, the aforementioned equipment can be utilized to present information to individuals (e.g., operators) that is then analyzed/tailored by the individuals. As an example of the manual approach, one or more individuals may be assigned to gather information and input it using the aforementioned equipment. Additionally, it is noted that the API/event activity provider 102 can be configured to identify events by analyzing raw/unprocessed information that is received through the API. For example, the API can receive an audio and/or video stream of any event (e.g., a sporting event, a concert event, an online gaming event, etc.) and utilize various techniques (e.g., machine learning) to effectively parse events that take place. It is noted that the foregoing examples are not meant to be limiting and that any approach can be utilized by the event activity provider 102 to effectively obtain and organize useful information about real-world events.

According to some embodiments, the event activity provider 102 can be configured to implement event analysis logic to enable key events 110 to be identified. More specifically, the event analysis logic can be configured to enforce a key event rule set that defines various criteria through which the key events 110 can be identified. In one example, the key event rule set can specify that, for baseball games, the key events include runs and homeruns. Other, more common events, such as strikeouts, walks, inning shifts, etc., may not qualify as key events 110. In another example, the key event rule set can specify that, for ice hockey games, the key events include goals and fights. In another example, the key event rule set can specify that, for football (soccer) matches, the key events include goals and goal scoring opportunities. It is noted that the foregoing examples are not meant to be limiting, and that the event activity provider can be configured to identify key events using any criteria, and any level of granularity, without departing from the scope of this disclosure. Once a key event 110 is identified, the event activity provider 102 can store information about circumstances related to the key event 110 (e.g., one or more times associated with the key event 110, contextual information associated with the key event 110, effects tied to the key event 110 (e.g., spokesperson/audience responses, outcome changes, etc.), audio/video content associated with the key event, and the like).

According to some embodiments, when a key event 110 is identified, the event activity provider 102 can be configured to provide information about the key event 110 to the media content analyzer 112. According to some embodiments, the media content analyzer 112 can be configured to receive, from various sources, media content 115 pertaining to various real-world events (e.g., concert events, gaming events, sporting events, award events, etc.). The media content 115 can represent, for example, audio and/or video streams that are live (with or without delay) or recorded. The media content 115 can include a primary audio and/or video stream assembled from a plurality of different audio and/or video sources over a continuous timeline. That is, a plurality of different audio and/or video sources may be used to provide content for the primary audio and/or video stream, but the utilized content from the different audio and/or video sources does not overlap temporally. The media content 115 can also include one or more secondary audio and/or video streams. Each secondary audio and/or video stream can include the audio and/or video stream from a corresponding one of the plurality of different audio and/or video sources.

As shown in FIG. 1, the media content analyzer 112 can be configured to implement media content analysis logic 114 for analyzing the media content 115 to generate replay clips 116. According to some embodiments, the media content analysis logic 114 is configured to identify and classify a plurality of segments in the media content 115. In one embodiment, the media content 115 is segmented and classified using machine learning. Each identified segment is tagged with at least one respective classification that describes the nature of the segment. The identified segments can be used to determine information to be extracted from the media content 115 based on the key events 110. Examples of different classifications include, but are not limited to, “Close Up.” “Wide angle,” “Crowd,” “Graphic,” “Replay,” “Lateral Angle,” “Split Screen,” “Bench,” “Transition,” “Sport-Specific (Sub-Classification),” “Referee,” “Time,” “Scoreboard,” “Unknown,” and the like.

“Close Up” can be used to classify the segment as displaying a close-up—i.e., a zoomed-in view—of a person, player, or other participant in the real-world event. “Wide angle” can be used to classify the segment as displaying a wide-angle view of the stage on which the real-world event takes place. For example, if the real-world event is a sporting event, then the stage is the playing surface, such as a field, a pitch, a rink, or the like. “Crowd” can be used to classify the segment as displaying a plurality of spectators watching the real-world event. “Graphic” can be used to classify the segment as displaying graphical information in addition to (or as an aside from) the real-world event. Graphics may be used to display various types of information, e.g., a statistical summary of the real-world event until that point, details on the people, players, or other participants in the real-world event, other related real-word events, advertising, and the like. “Replay” can be used to classify the segment as a replay of a previous activity within the real-world event. For example, the segment can be analyzed to determine if it is presented in slow motion, as slow motion presents a high likelihood that the segment is a replay. The segment can also be analyzed to determine whether it matches previously-presented content, which is also indicative that the segment is a replay.

“Lateral Angle” pertains to the distance between the “Close Up” and “Wide Angle” classifications. In this regard, “Lateral Angle” can be used to classify the segment as one that focuses on a player performing an action of interest, celebrations of goals, moments of referee intervention, and so on. “Split Screen” can be used to classify the segment as displaying two or more feeds (e.g., camera, animations, etc.) at the same time, e.g., video assistant referee (VAR) reviews. “Bench” is similar to “Close Up,” and can be used to classify the segment as one that focuses on the coach, players, managers, etc., in bench areas (e.g., dugouts, sidelines, penalty boxes, etc.). “Transition” can be used to classify the segment as one that transitions between a key moment and one or more replays in a manner that smoothly transitions between shots (e.g., when graphics associated with a team, league, broadcaster, etc., appear). “Sport-Specific (Sub-Classification)” can be used to classify the segment as one that is specific to a particular sport. For example, in soccer, there often are camera views from behind the goals, which could be classified as “Soccer (Back Goal Cam)”. In another example, in soccer, there often are camera views for penalties from the front of the goal, which could be classified as “Soccer (Penalty Cam)”. In yet another example, in soccer, there often are camera views for corners of the field, which could be classified as “Soccer (Corner Cam [1-4])”.

“Referee” can be used to classify the segment as one that includes one or more referees involved in the event. “Time” can be used to classify the segment as one that includes one or more representations of any time(s), timers, clocks, etc., related to the event, such as a running game timer, a sub-game timer (e.g., a shot clock”), a time-out timer, the current real-world time, and so on. “Scoreboard” can be used to classify the segment as one that includes one or more representations of scores, statistics, etc., related to the activity. The “Time” and/or “Scoreboard” classifications can be useful, for example, to detect connections between the times that activities occur during the events. Such classifications can also be useful to detect when replays occur, given, in most instances, scoreboard-related graphics are not displayed during replays. “Unknown” can be used to classify the segment as one that displays activity unrelated to the event of interest, such as commercial breaks.

Additionally, audio content that accompanies the segment can be analyzed to effectively classify segments (e.g., a spokesperson speaking words indicating a replay, such as “let's see that again”), graphical/text content (e.g., subtitles indicating a replay), and so on. It is noted that the foregoing examples are not meant to be limiting, and that any information associated with the media content can be analyzed, at any level of granularity, to effectively segment and classify the media content.

Additionally, and as shown in FIG. 1, the media content analyzer 112 can be configured to manage optical flow rule sets 113. According to some embodiments, each optical flow rule set 113 can correspond to one or more types of the real-world event (e.g., baseball, hockey, football, soccer, boxing, etc.), one or more types of the media content being analyzed (e.g., audio, video, text, etc.), the manner in which the media content is obtained (e.g., professional camera systems, audience cameras (e.g., mobile device cameras), the segments/classifications that are desired to be generated, and so on. It is noted that the foregoing examples are not meant to represent an exhaustive list, and that any number of optical flow rule sets 113 can be configured, and selected for use, based on any information, at any level of granularity, without departing from the scope of this disclosure.

According to some embodiments, a given optical flow rule set 113 can define optical flow rules that are effective for generating and classifying segments for media content associated with a real-world event. Optical flow can be defined as the pattern of apparent motion of objects, surfaces, and edges in a visual scene caused by the relative motion between an observer and the scene. Optical flow can also be defined as the distribution of apparent velocities of movement of brightness pattern in an image. Thus, the nature of the real-world event will dictate the optical flow of the video stream for that event. Examples of optical flow characteristics of the video stream can include a camera panning direction (for example, left or right), a change in the camera panning direction (for example, from left to right or right to left), a change in the camera panning speed without changing direction (for example, acceleration or deceleration of the panning), a change in the camera zoom level (for example, from zooming in to zooming out and from zooming out to zooming in), a change in the camera zoom speed (for example, acceleration or deceleration of the zooming), a slow-down of the video stream (indicative of a replay), a change in the video source, and the like.

The ability to extrapolate significant occurrences is particularly useful for real-world events that are fluid and do not have clearly defined significant occurrences. For example, in a football (soccer) match, a significant amount of time can elapse from the time a reset occurs (such as a throw-in or a goal kick) until the time a goal is scored. Accordingly, one or more optical flow rule sets 113 can be used to extrapolate significant occurrences from the optical flow of one or more content streams (e.g., audio, video, text, etc.). For example, in a football (soccer) match, a change in possession prior to a goal—which can constitute a key event 110—may be an appropriate/relevant starting point for a replay clip 116. Notably, a change in possession often results in a change in the camera panning direction. Accordingly, the optical flow rule set 113 may include a rule for detecting a change in the camera panning direction shortly prior to the goal to identify the starting point for the replay clip 116. Once the goal has been scored, the camera feed may change to capture celebrations from the players, managers, coaches, audience, and so on. Accordingly, the optical flow rule set 113 may include a rule for detecting a change in camera feed shortly after the goal to identify the ending point for the replay clip 116. In an embodiment, it may be desirable to include goal celebrations in the replay clip 116, in which case a different/supplemental rule for the ending point may be used.

Similarly, in hockey, a significant amount of time can elapse from a reset (such as a face-off) until a goal is scored, for example. In hockey, for example, a breakaway prior to a goal—which can constitute a key event 110—may be an appropriate/relevant starting point for a replay clip 116. Typically, a breakaway will result in a change in the camera panning speed. Accordingly, the optical flow rule set 113 may include a rule for detecting a change in the camera panning speed shortly prior to the goal for the replay clip 116. Once the goal has been scored, the camera feed may change to capture celebrations from the players, managers, coaches, audience, and so on. Accordingly, the optical flow rule set 113 may include a rule for detecting a change in camera feed shortly after the goal to identify the ending point for the replay clip 116.

Accordingly, it should be appreciated that the optical flow rule set 113 can include different rules for different real-world events based on the optical flow associated with visually capturing the event. Further, multiple optical flow characteristics may be analyzed in various combinations to improve identification of significant occurrences within the event. Yet further, the identification of significant occurrences may also depend on classifications of segments, as described herein. Yet further, the audio stream of the media content 115 may also be used to supplement the optical flow rule set. For example, an increase or decrease in the volume of crowd noise, an increase or decrease in the volume of the announcer, and the like, can be utilized to identify significant occurrences.

Accordingly, in one example, the media content analyzer 112 receives a key event 110 that indicates a goal occurred at 5:55:22 PM in a particular football (soccer) match. In turn, the media content analyzer 112 can determine whether the media content 115 includes information pertaining to the particular football (soccer match), such as a live stream/ongoing recording thereof. In turn, assuming the media content 115 does include the information, the media content analysis logic 114 can identify the appropriate optical flow rule set(s) 113 (e.g., using the selection techniques discussed herein) to extract information from the media content 115 based on the key event 110. For example, the media content analysis logic 114 can extract a segment based on the time of 5:55:22 PM indicated in the key event 110. A change in possession (e.g., at a time of 5:48:44 PM) may be extrapolated from the optical flow analysis of the segment (and/or other information included in the media content). Accordingly, the starting point for the replay clip 116 can be set to occur shortly before the time of the change in possession (e.g., based on a padding time specified in the optical flow rule set(s) 113). The ending point for the replay clip 116 can be set to occur at the ending point of the analyzed segment.

Replay clips 116 generated by the media content analyzer 112 can be provided by the media content analyzer 112 to one or more media content libraries 118. According to some embodiments, a media content library 118 that receives a replay clip 116 can be configured to store the replay clip 116 using any conceivable approach. For example, the media content library 118 can store the replay clip 116 into a database to which the media content library 118 is communicably coupled. In doing so, the media content library 118 can generate a unique identifier to identify the replay clip 116. In one embodiment, the media content library 118 can provide the unique identifier to the media content analyzer 112. In turn, the media content analyzer 112 can associate the unique identifier with the key event 110 that correlates to the replay clip 116. It is noted that the key events 110 described herein are not limited to single/respective replay clips 116. On the contrary, a given key event 110 can refer to any number of replay clips 116 that the media content analyzer 112 determines are relevant to the key event 110. When this occurs, the media content library 118 can generate respective unique identifiers for the media content clips 116.

The replay clips 116 and each associated unique identifier can also be provided by the media content library 118 to one or more replay clip distributors 120. In one embodiment, the replay clip distributor 120 can maintain the necessary information to manage subscription preferences of a plurality of users of the client computing devices 124. For example, a fan of a particular sports team can subscribe to receive replay clips 116 for that sports team in real-time (or near real-time). The replay clip distributor 120 can also be configured to respond to a request for the replay clips 116. For example, a fan of a particular sports team can search for replay clips for that sports team. The replay clip distributor 120 can push the key event 110 and the associated replay clip 116 to the client computing devices 124 of the users in accordance with the subscription preferences. In one example, the key event 110 and the replay clip 116 can be sent separately. That is, the key event 110 can be pushed to the client computing devices 124 and displayed thereon (e.g., on a display device that is communicably coupled to the client computing device 124) for interaction with the user. The replay clip 116 can then be retrieved (e.g., stream or download) by the client computer devices 124 in response to a request from the user during the interaction. In another example, the replay clip distributor 120 can push the replay clip 116 to the users/client computing devices 124 along with the key event 110. In such an example, the user of the client computing device 124 would not need to obtain the replay clip 116 separately from the key event 110. In either example, the user of the client computing devices 124 may be an individual user or an administrator of a broadcast platform, such as one or more social media platforms, for example.

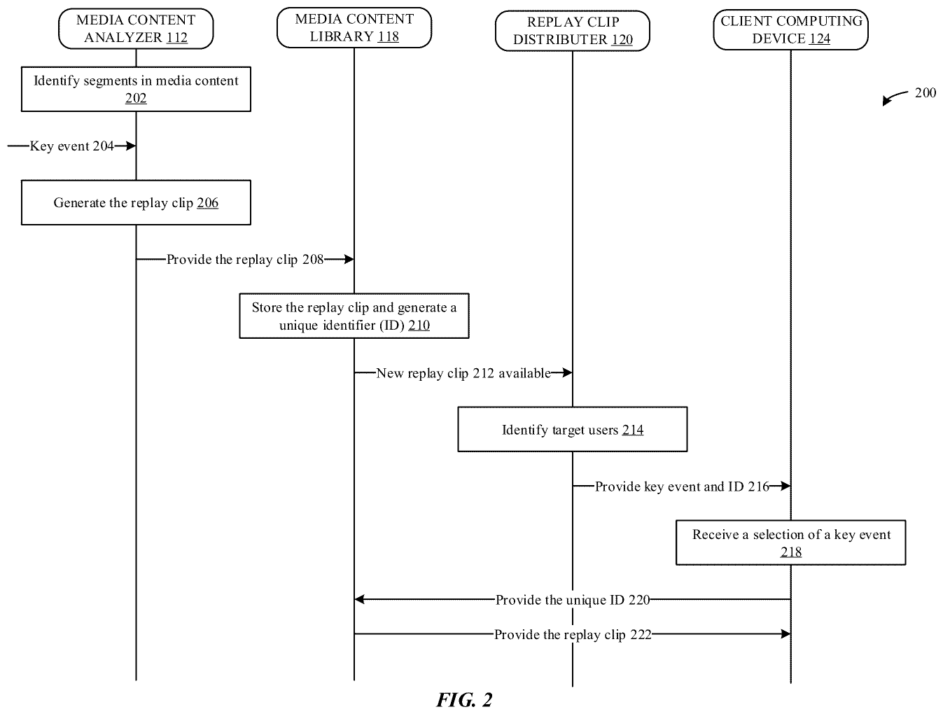

Accordingly, FIG. 1 sets forth a system that can enable replay clips 116 associated with key real-world events to be automatically generated and provided to users/client computing devices 124. A more detailed breakdown of the interactions between the various entities illustrated in FIG. 1 (and described above) is provided below in conjunction with FIG. 2.

FIG. 2 illustrates a sequence diagram 200 of interactions between a media content analyzer 112, a media content library 118, a replay clip distributor 120, and a client computing device 124 to enable the techniques discussed herein to be implemented, according to some embodiments. A step 202 can involve the media content analyzer 112 identifying and classifying segments from the media content 115 (e.g., using the techniques described herein).

A step 204 involves the media content analyzer 112 receiving a key event 110 from the event activity provider 102. The request can include, for example, the key event 110 (or a subset of information stored by the key event 110), as well as the time of the key event 110.

Next, a step 206 involves the media content analyzer 112 generating a replay clip 116 (e.g., using the techniques described herein). In turn, a step 208 involves the media content analyzer 112 providing the replay clip 116 to the media content library 118 (e.g., using the techniques described herein). At step 210, the media content library 118 stores the replay clip 116 and generates the unique identifier.

In turn, at step 212, the media content library 118 provides the unique identifier to the replay clip distributor 120 (e.g., using the techniques described herein). Next, at step 214, the replay clip distributor 120 identifies the user or users that have subscribed to the information (e.g., using the techniques described herein).

Accordingly, at step 216, the replay clip distributor 120 provides one or more key events 110 to the client computing device 124 (e.g., using the techniques described herein). Again, the replay clip distributor 120 can provide the one or more key events 110 in response to a request (e.g., a search query, a page load, etc.) that is issued by the client computing device 124. In another example, the replay clip distributor 120 can determine, e.g., by analyzing preferences and/or subscriptions of a user associated with the client computing device 124, that the user may be interested in the one or more key events 110.

At step 218, the client computing device 124 receives a selection of one of the one or more key events 110 that are provided by the replay clip distributor 120 in step 216. The selection can occur, for example, when a user is interacting with a particular key event 110 of the one or more key events 110 and selects an available option associated with the particular key event 110 (e.g., an option to view the media content clip 116 associated with the particular key event 110).

Next, at step 220, the client computing device 124 obtains the unique identifier for the selected key event 110 and provides the unique identifier to the media content library 118 (e.g., as described above in conjunction with FIG. 1). In turn, at step 222 the media content library 118 obtains the media content clip 116 based on the unique identifier and provides the media content clip 116 to the client computing device 124 (e.g., as described above in conjunction with FIG. 1). Thereafter (and not illustrated in FIG. 2), the client computing device 124 can enable its user to interact with the media content clip 116 (e.g., playback the media content clip 116, share the media content clip 116 with others, and so on).

In another embodiment, rather than provide the key event and ID as at step 216, the replay clip distributor 120 can retrieve the replay clip 116 from media content library 118. The replay clip distributor 120 can then send the replay clip 116 to the client computing device 124 without requiring that the client computing device 124 explicitly request the replay clip 116.

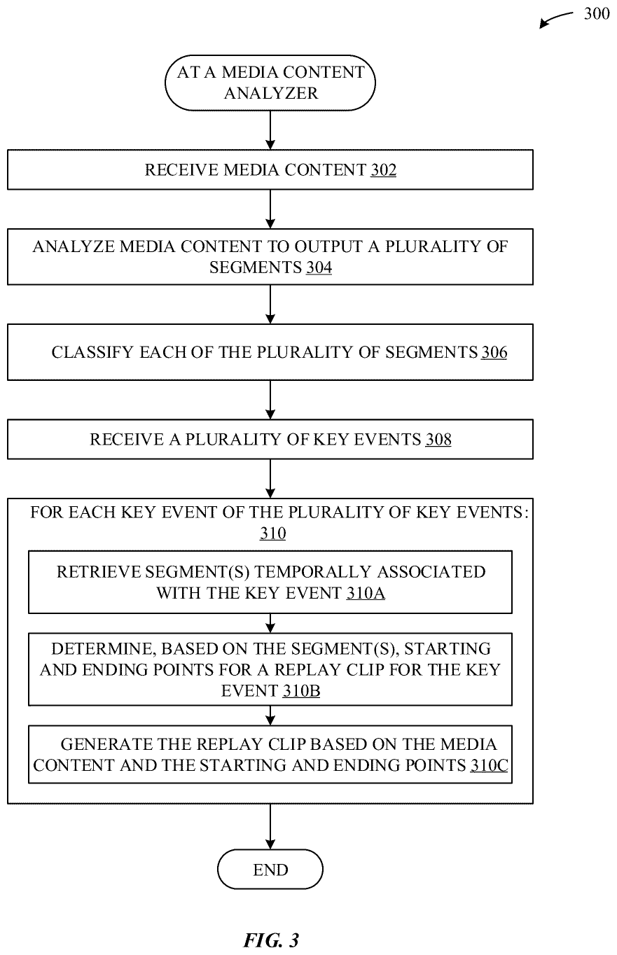

FIG. 3 illustrates a method 300 for dynamically generating replay clips 116 based on key 110 events that occur, according to some embodiments. According to some embodiments, the method can be implemented by one or more computing devices associated with the media content analyzer 112. As shown in FIG. 3, the method 300 begins at step 302, where the media content analyzer 112 receives media content 115. As previously described, the media content 115 can be audio, video, text, etc., streams that are live (with or without delay) or recorded.

At step 304, the media content analyzer 112 utilizes at least one machine learning model configured to analyze the media content 115 and output a plurality of segments of the media content 115. In one embodiment, the primary audio and/or video stream (i.e., media stream) of the media content 115 is analyzed on a frame-by-frame (or other) basis using machine learning to detect transitions in the media stream. According to some embodiments, detecting a transition can involve identifying the end of a current segment and the start of the next segment. Specifically, once the transition has been detected, the frame immediately prior to the frame comprising the transition is identified as the last frame in a current segment and the frame comprising the transition is identified as the first frame in the next segment. An example of a transition includes a change in a camera feed (e.g., a change in the secondary audio and/or video streams that is being used for the primary audio and/or video stream). Another example of a transition includes introduction of a graphic into the primary video stream. Yet another example of a transition includes a change in the graphic in the primary video stream. Yet another example of a transition includes fading from one video stream (i.e., shot) to another video stream (which often occurs between shots of a replay).

At step 306, the media content analyzer 112 utilizes at least one machine learning model to classify each segment of the plurality of segments as they are identified (e.g., using one or more of the optical flow rule sets 113 described herein). According to some embodiments, each segment can be tagged with at least one respective classification that describes the nature of the segment (e.g., a field shot, a close up shot, a slow-motion replay, etc.). Respective confidence levels in the classifications may also be determined on a scale of 0.00 to 1.00 (or other scale), which can function as respective weights when utilizing the segments to generate replay clips 116.

At step 308, the media content analyzer 112 receives a plurality of key events 110. At step 310, for each key event 110, the media content analyzer 112 analyzes at least one segment of the plurality of segments against the key event 110 to determine starting and ending points for a replay clip 116 for the key event 110. For example, as previously described, the received key events 110 can include the identification of the key events 110 as well as the time at which the key events 110 occurred. In one embodiment, at step 310a, the media content analyzer 112 identifies and retrieves a primary segment that temporally corresponds to the key event 110. In this manner, the retrieved segment presumably includes content of the key event 110 itself (e.g., a goal being scored). The media content analyzer 112 may also retrieve any number of additional segments that occur before, during (e.g., another camera feed, audio feed, etc.), and/or after the primary segment. In some embodiments, segments classified purely as graphical (e.g., a score screen, a player profile screen, a team profile screen, etc.) may be disregarded as they likely would not add anything relevant to the replay clip 116.

At step 310b, the media content analyzer 112 determines, based on the segments, the starting and ending points for the replay clip 116 (e.g., using the techniques described herein). For example, the starting and ending points of the replay clip 116 can be determined as the starting and ending points of the primary segment, starting and/or ending points of the primary segment that are adjusted based on other segments (e.g., the classifications thereof), and so on.

At step 310c, the media content analyzer 112 generates the replay clip 116 based on the media content and the starting and ending points. In one embodiment, the replay clip 116 may include only the audio and/or video from the primary audio and/or video stream. Accordingly, if it is determined that the starting point is at Time 1 and the ending point is at Time 2, then the replay clip 116 can include the primary audio and/or video stream from Time 1 to Time 2. In another embodiment, the replay clip 116 may include the audio and/or video from one or more of the secondary audio and/or video streams. Thus, for example, the replay clip 116 can include the primary audio and/or video stream from Time 1 to Time 2, as well as the audio and/or video streams from Time 1 to Time 2 for one or more of the secondary audio and/or video streams. It should be appreciated that if one of the secondary audio and/or video streams is substantially the same as the primary audio and/or video stream, then it can be omitted from the replay clip 116 to avoid redundancy. In yet another embodiment, the replay clip 116 can include portions of different ones of the audio and/or video streams from Time 1 to Time 2.

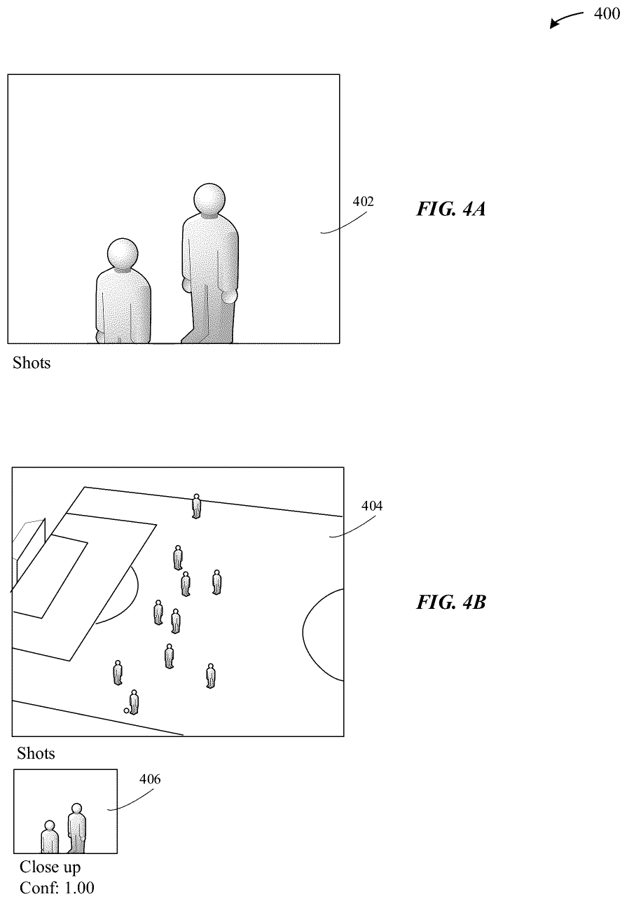

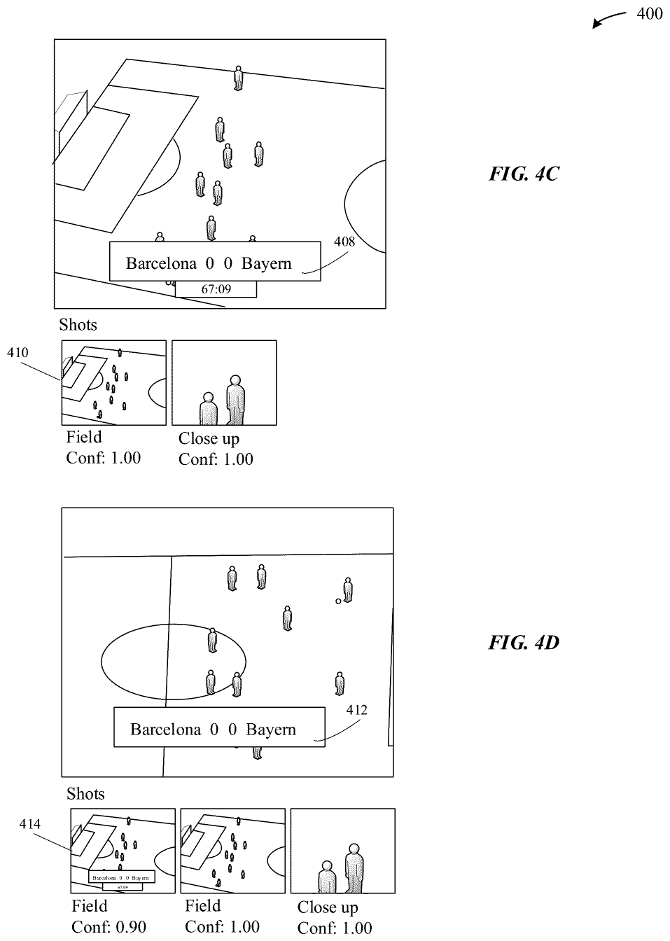

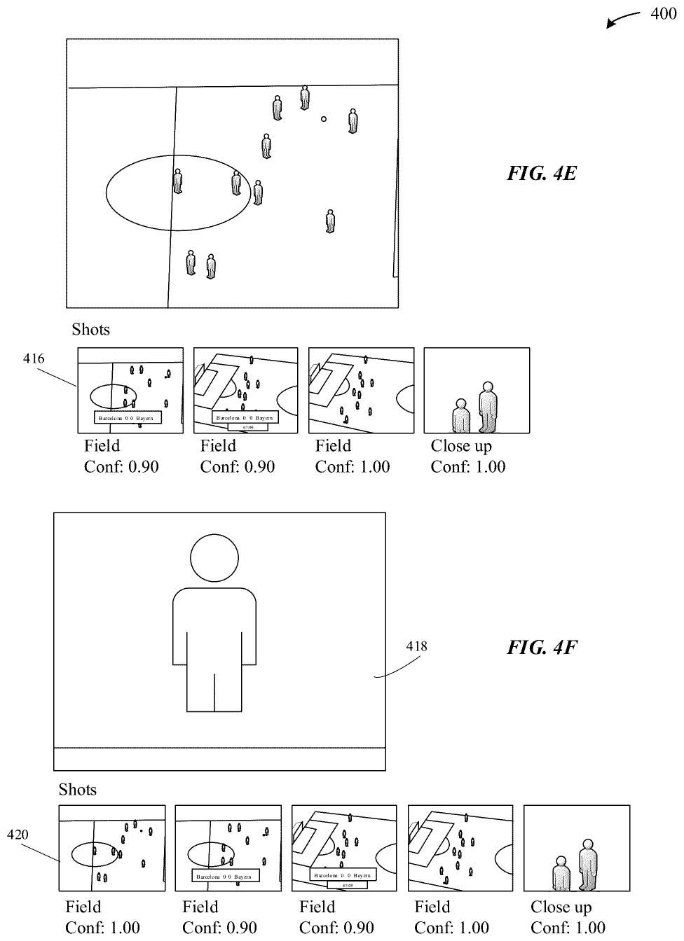

FIGS. 4A-4F illustrate conceptual diagrams 400 of an example process through which the media content analyzer 112 identifies and classifies segments within media content 115 that is accessible to the media content analyzer 112, according to some embodiments. As a first step, the media content analyzer 112 can employ the media content analysis logic 114 to identify one or more optical flow rule sets 113 that are appropriate for analyzing the media content 115 (e.g., based on the type(s) of the media content 115 (e.g., audio, video, text, etc.), the type(s) of event(s) to which the media content 115 corresponds (e.g., sport type(s), activity type(s), etc.), the systems used to generate the media content 115 (e.g., the types of cameras, microphones, detection devices, etc.), and so on. It is noted that the foregoing examples are not meant to be limiting, at that the optical flow rule sets 113 can be formulated and selected based on any type of information, at any level of granularity, without departing from the scope of this disclosure. In any case, when the media content analyzer 112 selects the appropriate optical flow rule set(s) 113, it can then begin analyzing the media content 115 to generate and classify segments in accordance with the techniques described herein.

As shown in FIG. 4A, the video stream of the media content 115 includes a close up view 402 from a first camera Camera 1. As shown in FIG. 4B, the video stream has switched to a wide-angle view of the field 404 from a second camera Camera 2. Accordingly, the media content analyzer 112 detects the change in camera and creates a first segment 406. The first segment 406 ends just prior to the camera switch and is classified as “Close Up” with a degree of confidence of 1.00 (i.e., complete confidence). As described herein, it is noted that two or more classifications can be assigned to any segment that satisfies the requirements, characteristics, properties, etc., of the classifications.

As shown in FIG. 4C, the video stream is still a wide-angle view from the second camera Camera 2, but a graphic 408 has been inserted into the video stream. The graphic 408 includes, for example, the score and the current time of the game. Accordingly, the media content analyzer 112 detects the addition of the graphic 408 and creates a second segment 410. The second segment 410 begins immediately after the end of the first segment 406 and ends just prior to the addition of the graphic 408. The second segment 410 is classified as “Field” with a degree of confidence of 1.00.

As shown in FIG. 4D, the video stream is still a wide-angle view from the second camera Camera 2, but the graphic 408 has changed to graphic 412. Specifically, the graphic 412 no longer includes the time that was included in the graphic 408. Accordingly, the media content analyzer 112 detects the change from graphic 408 to graphic 412 and creates a third segment 414. The third segment 414 begins immediately after the end of the second segment 410 and ends just prior to the modification of the graphic 408/the introduction of the graphic 412. Although the third segment 414 includes the graphic 408, the graphic 408 does not substantially interfere with the view of the field. Accordingly, the third segment 414 is classified as “Field” and not “Graphic” with a degree of confidence of 0.90.

As shown in FIG. 4E, the video stream is still a wide-angle view from the second camera Camera 2 but the graphic 412 has been removed entirely. Accordingly, the media content analyzer 112 detects the removal of the graphic 412 and creates a fourth segment 416. The fourth segment 416 begins immediately after the end of the third segment 414 and ends just prior to the removal of the graphic 412. Similar to FIG. 4D, although the fourth segment 416 includes the graphic 412, the graphic 412 does not substantially interfere with the view of the field. Accordingly, the fourth segment 416 is classified as “Field” and not “Graphic” with a degree of confidence of 0.90.

As shown in FIG. 4F, the video stream has switched to a close up view 418 from a third camera Camera 3. Accordingly, the media content analyzer 112 detects the change in camera and creates a fifth segment 420. The fifth segment 420 begins immediately after the end of the fourth segment 416 and ends just prior to the camera switch. The fifth segment 420 is classified as “Field” with a degree of confidence of 1.00.

Accordingly, upon receipt of a key event 110 that corresponds to the segments described above in conjunction with FIGS. 4A-4F, the media content analyzer 112 determines, from the time the key event 110 occurred, that the key event 110 is contained within the fifth segment 420 (i.e., the primary segment). In one embodiment, and as described herein, the media content analyzer 112 retrieves the fifth segment 420 and identifies the starting and ending points of the replay clip 116 as the beginning and ending points of the fifth segment 420, respectively. In another embodiment, the media content analyzer 112 can apply football (i.e., soccer) specific rules from one or more optical flow rule sets 113 to the fifth segment 420 (or any the other segments). If the media content analyzer 112 detects a significant occurrence, such as a change of possession (e.g., as indicated by a shift in camera panning), within the segments, then the starting point of the replay clip 116 may be set to just prior to the significant occurrence (e.g., based on dynamic padding rules defined in the optical flow rule sets 113). In yet another embodiment, the media content analyzer 112 can wait to obtain and analyze additional (i.e., future) media content 115 to generate and classify additional segments that can be used to generate the replay clip 116.

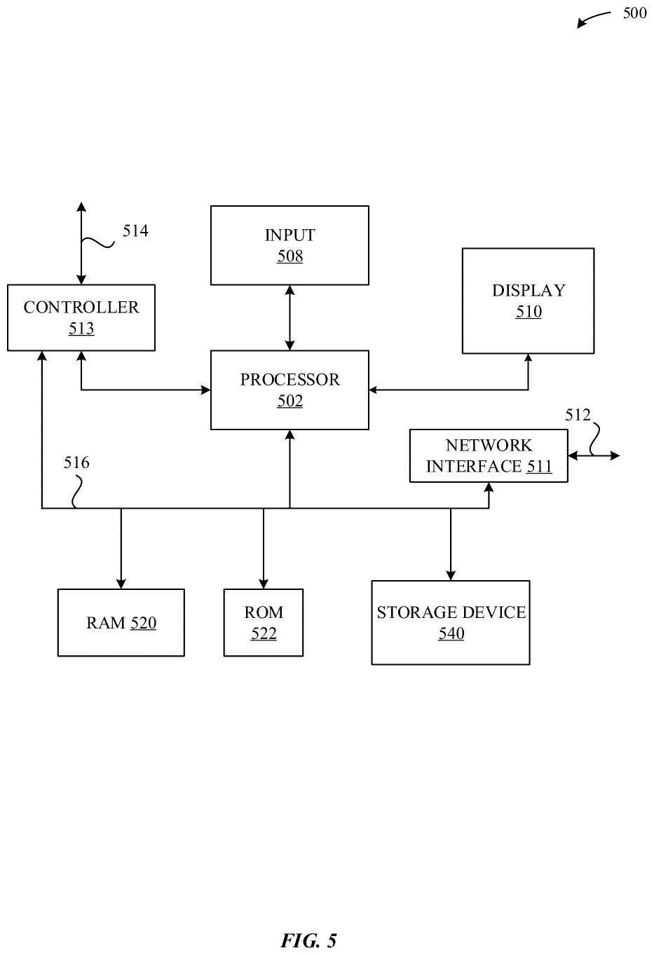

FIG. 5 illustrates a detailed view of a computing device 500 that can be used to implement the various components described herein, according to some embodiments. In particular, the detailed view illustrates various components that can be included in any of the computing devices described above in conjunction with FIG. 1.

As shown in FIG. 5, the computing device 500 can include a processor 502 that represents a microprocessor or controller for controlling the overall operation of computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, etc. Furthermore, the computing device 500 can include a display 510 (screen display) that can be controlled by the processor 502 to display information to the user. A data bus 516 can facilitate data transfer between at least a storage device 540, the processor 502, and a controller 513. The controller 513 can be used to interface with and control different equipment through and equipment control bus 514. The computing device 500 can also include a network/bus interface 511 that couples to a data link 512. In the case of a wireless connection, the network/bus interface 511 can include a wireless transceiver.

The computing device 500 also includes a storage device 540, which can comprise a single disk or a plurality of disks (e.g., SSDs), and includes a storage management module that manages one or more partitions within the storage device 540. In some embodiments, storage device 540 can include flash memory, semiconductor (solid state) memory or the like. The computing device 500 can also include a Random-Access Memory (RAM) 520 and a Read-Only Memory (ROM) 522. The ROM 522 can store programs, utilities, or processes to be executed in a non-volatile manner. The RAM 520 can provide volatile data storage, and stores instructions related to the operation of the computing devices described herein.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for dynamically generating replay clips for key events that occur, the method comprising, at a computing device:
providing media content to at least one machine learning model to output a plurality of segments of the media content, wherein each segment is tagged with a respective at least one classification that describes a nature of the segment;
receiving a plurality of key events; and
for each key event of the plurality of key events:
analyzing at least one segment of the plurality of segments against the key event to determine starting and ending points for a replay clip for the key event, and
generating the replay clip based on (i) the media content, and (ii) the starting and ending points.

2. The method of claim 1, further comprising, for each key event:
analyzing optical flow of the plurality of segments against the key event to determine the starting and ending points for the replay clip for the key event.

3. The method of claim 2, wherein the optical flow comprises one or more of a camera panning direction, a change in camera panning direction, a change in camera panning speed, a change in camera zoom level, a change in camera zoom speed, or a change in camera source video.

4. The method of claim 1, further comprising, for each key event:
analyzing audio data of the plurality of segments against the key event to determine the starting and ending points for the replay clip for the key event.

5. The method of claim 1, wherein the media content comprises media content from a plurality of different video sources.

6. The method of claim 5, wherein the replay clip is generated using the media content from the plurality of different video sources.

7. The method of claim 6, wherein the replay clip is generated using the media content by splicing different ones of the plurality of different video sources to create an optimal replay clip.

8. The method of claim 1, further comprising:
omitting, from the replay clip, one or more of the plurality of segments of the media content between the starting and ending points based on the at least one respective classification.

9. The method of claim 1, further comprising:
selecting the at least one machine learning model based on one or more of a type of the media content, a type of an event to which the media content corresponds, or a type of a device that generates the media content.

10. A non-transitory computer readable storage medium configured to store instructions that, when executed by a processor included in a computing device, cause the computing device to generate replay clips for key events that occur, by carrying out steps that include:
providing media content to at least one machine learning model to output a plurality of segments of the media content, wherein each segment is tagged with a respective at least one classification that describes a nature of the segment;
receiving a plurality of key events; and
for each key event of the plurality of key events:
analyzing at least one segment of the plurality of segments against the key event to determine starting and ending points for a replay clip for the key event, and
generating the replay clip based on (i) the media content, and (ii) the starting and ending points.

11. The non-transitory computer readable storage medium of claim 10, wherein the steps further include, for each key event:
analyzing optical flow of the plurality of segments against the key event to determine the starting and ending points for the replay clip for the key event.

12. The non-transitory computer readable storage medium of claim 10, wherein the steps further include, for each key event:
analyzing audio data of the plurality of segments against the key event to determine the starting and ending points for the replay clip for the key event.

13. The non-transitory computer readable storage medium of claim 10, wherein the media content comprises media content from a plurality of different video sources.

14. The non-transitory computer readable storage medium of claim 10, wherein the steps further include:
omitting, from the replay clip, one or more of the plurality of segments of the media content between the starting and ending points based on the respective at least one classification.

15. The non-transitory computer readable storage medium of claim 10, wherein the steps further include:
selecting the at least one machine learning model based on one or more of a type of the media content, a type of an event to which the media content corresponds, or a type of a device that generates the media content.

16. A computing device, comprising:
at least one processor; and
at least one memory storing instructions that, when executed by the at least one processor, cause the computing device to generate replay clips for key events that occur, by carrying out steps that include:
providing media content to at least one machine learning model to output a plurality of segments of the media content, wherein each segment is tagged with a respective at least one classification that describes a nature of the segment;
receiving a plurality of key events; and
for each key event of the plurality of key events:
analyzing at least one segment of the plurality of segments against the key event to determine starting and ending points for a replay clip for the key event, and
generating the replay clip based on (i) the media content, and (ii) the starting and ending points.

17. The computing device of claim 16, wherein the steps further include, for each key event:
analyzing optical flow of the plurality of segments against the key event to determine the starting and ending points for the replay clip for the key event.

18. The computing device of claim 16, wherein the steps further include, for each key event:
analyzing audio data of the plurality of segments against the key event to determine the starting and ending points for the replay clip for the key event.

19. The computing device of claim 16, wherein the steps further include:
omitting, from the replay clip, one or more of the plurality of segments of the media content between the starting and ending points based on the respective at least one classification.

20. The computing device of claim 16, wherein the steps further include:
selecting the at least one machine learning model based on one or more of a type of the media content, a type of an event to which the media content corresponds, or a type of a device that generates the media content.
